(19) United States
(12) Patent Application Publication
(10) Pub. No.: US 2020/0045279 A1
(43) Pub. Date: Feb. 6, 2020

(54) IMAGING APPARATUS AND ENDOSCOPE APPARATUS

(71) Applicant: OLYMPUS CORPORATION, Tokyo (JP)

(72) Inventor: Hiroshi SAKAI, Sagamihara-shi (JP)

(73) Assignee: OLYMPUS CORPORATION, Tokyo (JP)

(21) Appl. No.: 16/599,223

(22) Filed: Oct. 11, 2019

Related U.S. Application Data
(63) Continuation of application No. PCT/JP2017/015706, filed on Apr. 19, 2017.

(51) Int. Cl. H04N 9/64; H04N 9/04; H04N 5/232

(52) U.S. Cl. CPC H04N 9/646; H04N 9/04551; H04N 2005/2255; H04N 5/23229; H04N 5/23245

(57) ABSTRACT

In an imaging apparatus, a processor is configured to generate at least one of a first monochrome correction image and a second monochrome correction image as a monochrome correction image. The first monochrome correction image is an image generated by correcting a value based on components overlapping between a first transmittance characteristic and a second transmittance characteristic for a captured image having components based on the first transmittance characteristic. The second monochrome correction image is an image generated by correcting a value based on components overlapping between the first transmittance characteristic and the second transmittance characteristic for the captured image having components based on the second transmittance characteristic. The processor is configured to superimpose a mark on the monochrome correction image or a processed image generated by processing the monochrome correction image on the basis of point information.

The present application is a continuation application based on International Patent Application No. PCT/JP2017/015706 filed on Apr. 19, 2017, the content of which is incorporated herein by reference.

### BACKGROUND OF THE INVENTION

### Field of the Invention

The present invention relates to an imaging apparatus and an endoscope apparatus.

### Description of Related Art

Imaging devices having color filters of primary colors consisting of R (red), G (green), and B (blue) have been widely used for an imaging apparatus in recent years. When a band of the color filter becomes wide, the amount of transmitted light increases and imaging sensitivity increases. For this reason, in a typical imaging device, a method of causing transmittance characteristics of R, G, and B color filters to intentionally overlap is used.

In a phase difference AF or the like, phase difference detection using a parallax between two pupils is performed. For example, in Japanese Unexamined Patent Application, First Publication No. 2013-044806, an imaging apparatus including a pupil division optical system having a first pupil area transmitting R and G light and a second pupil area transmitting G and B light is disclosed. A phase difference is detected on the basis of a positional deviation between an R image and a B image acquired by a color imaging device mounted on this imaging apparatus.

### SUMMARY OF THE INVENTION

According to a first aspect of the present invention, an imaging apparatus includes a pupil division optical system, an imaging device and a processor. The pupil division optical system includes a first pupil transmitting light of a first wavelength band and a second pupil transmitting light of a second wavelength band different from the first wavelength band. The imaging device is configured to capture an image of light transmitted through the pupil division optical system and a first color filter having a first transmittance characteristic and light transmitted through the pupil division optical system and a second color filter having a second transmittance characteristic partially overlapping the first transmittance characteristic, and output the captured image. The processor is configured to generate at least one of a first monochrome correction image and a second monochrome correction image as a monochrome correction image. The first monochrome correction image is an image generated by correcting a value that is based on components overlapping between the first transmittance characteristic and the second transmittance characteristic for the captured image having components that are based on the first transmittance characteristic. The second monochrome correction image is an image generated by correcting a value that is based on components overlapping between the first transmittance characteristic and the second transmittance characteristic for the captured image having components that are based on the second transmittance characteristic. The processor is configured to generate point information that represents a point on the monochrome correction image in accordance with an instruction from a user. The processor is configured to generate a mark. The processor is configured to superimpose the mark on the monochrome correction image or a processed image generated by processing the monochrome correction image on the basis of the point information and output the monochrome correction image or the processed image on which the mark is superimposed to a display unit.

According to a second aspect of the present invention, in the first aspect, the processor may be configured to generate the first monochrome correction image and the second monochrome correction image. The processor is configured to select at least one of the first monochrome correction image and the second monochrome correction image and output the selected image as the monochrome correction image.

According to a third aspect of the present invention, in the second aspect, the processor may be configured to select an image having a higher signal-to-noise ratio (SNR) out of the first monochrome correction image and the second monochrome correction image.

According to a fourth aspect of the present invention, in the second aspect, the processor may be configured to select at least one of the first monochrome correction image and the second monochrome correction image in accordance with an instruction from a user.

According to a fifth aspect of the present invention, in the second aspect, the processor is configured to calculate a phase difference between the first monochrome correction image and the second monochrome correction image. The point information may represent a measurement point that is a position at which the phase difference is calculated.

According to a sixth aspect of the present invention, in the second aspect, the processor may be configured to generate a third monochrome correction image and a fourth monochrome correction image. The third monochrome correction image is an image generated by correcting a value that is based on components overlapping between the first transmittance characteristic and the second transmittance characteristic for the captured image having components that are based on the first transmittance characteristic. The fourth monochrome correction image is an image generated by correcting a value that is based on components overlapping between the first transmittance characteristic and the second transmittance characteristic for the captured image having components that are based on the second transmittance characteristic. The processor may be configured to calculate a phase difference between the third monochrome correction image and the fourth monochrome correction image. The point information may represent a measurement point that is a position at which the phase difference is calculated.

According to a seventh aspect of the present invention, in the second aspect, the processor may be configured to designate at least one mode included in a plurality of modes in accordance with an instruction from a user. The processor may be configured to generate a processed image by performing image processing corresponding to the mode on at least part of the selected monochrome correction image and output the generated processed image to the display unit.

According to an eighth aspect of the present invention, in the seventh aspect, the processor may be configured to generate the processed image by performing at least one of enlargement processing, edge extraction processing, edge enhancement processing, and noise reduction processing on at least part of the monochrome correction image.

According to a ninth aspect of the present invention, in the seventh aspect, the processor may be configured to generate the processed image by performing enlargement processing and at least one of edge extraction processing, edge enhancement processing, and noise reduction processing on at least part of the monochrome correction image.

According to a tenth aspect of the present invention, an imaging apparatus includes a pupil division optical system, an imaging device, a correction unit, a user instruction unit, a mark generation unit, and a superimposition unit. The pupil division optical system includes a first pupil transmitting light of a first wavelength band and a second pupil transmitting light of a second wavelength band different from the first wavelength band. The imaging device is configured to capture an image of light transmitted through the pupil division optical system and a first color filter having a first transmittance characteristic and light transmitted through the pupil division optical system and a second color filter having a second transmittance characteristic partially overlapping the first transmittance characteristic, and output the captured image. The correction unit is configured to output at least one of a first monochrome correction image and a second monochrome correction image as a monochrome correction image. The first monochrome correction image is an image generated by correcting a value that is based on components overlapping between the first transmittance characteristic and the second transmittance characteristic for the captured image having components that are based on the first transmittance characteristic. The second monochrome correction image is an image generated by correcting a value that is based on components overlapping between the first transmittance characteristic and the second transmittance characteristic for the captured image having components that are based on the second transmittance characteristic. The user instruction unit is configured to output point information that represents a point on the monochrome correction image in accordance with an instruction from a user. The mark generation unit is configured to generate a mark. The superimposition unit is configured to superimpose the mark on the monochrome correction image or a processed image generated by processing the monochrome correction image on the basis of the point information and output the monochrome correction image or the processed image on which the mark is superimposed to a display unit.

According to an eleventh aspect of the present invention, in the tenth aspect, the correction unit may be configured to output the first monochrome correction image and the second monochrome correction image. The imaging apparatus may further include a selection unit configured to select at least one of the first monochrome correction image and the second monochrome correction image output from the correction unit and output the selected image as the selected monochrome correction image.

According to a twelfth aspect of the present invention, in the eleventh aspect, the imaging apparatus may further include a selection instruction unit configured to instruct the selection unit to select at least one of the first monochrome correction image and the second monochrome correction image. The selection unit may be configured to select at least one of the first monochrome correction image and the second monochrome correction image in accordance with an instruction from the selection instruction unit.

According to a thirteenth aspect of the present invention, an endoscope apparatus includes the imaging apparatus according to the first aspect.

### BRIEF DESCRIPTION OF THE DRAWINGS

FIG. 1 is a block diagram showing a configuration of an imaging apparatus according to a first embodiment of the present invention.

FIG. 2 is a block diagram showing a configuration of a pupil division optical system according to the first embodiment of the present invention.

FIG. 3 is a block diagram showing a configuration of a band limiting filter according to the first embodiment of the present invention.

FIG. 4 is a diagram showing a pixel arrangement of a Bayer image in the first embodiment of the present invention.

FIG. 5 is a diagram showing a pixel arrangement of an R image in the first embodiment of the present invention.

FIG. 6 is a diagram showing a pixel arrangement of a G image in the first embodiment of the present invention.

FIG. 7 is a diagram showing a pixel arrangement of a B image in the first embodiment of the present invention.

FIG. 8 is a diagram showing an example of spectral characteristics of an RG filter of a first pupil, a BG filter of a second pupil, and color filters of an imaging device in the first embodiment of the present invention.

FIG. 9 is a diagram showing an example of spectral characteristics of an RG filter of a first pupil, a BG filter of a second pupil, and color filters of an imaging device in the first embodiment of the present invention.

FIG. 10 is a block diagram showing a configuration of an imaging apparatus according to a second embodiment of the present invention.

FIG. 11 is a block diagram showing a configuration of an imaging apparatus according to a third embodiment of the present invention.

FIG. 12 is a block diagram showing a configuration of an imaging apparatus according to a fourth embodiment of the present invention.

FIG. 13 is a flow chart showing a procedure of an operation of a selection instruction unit according to the fourth embodiment of the present invention.

FIG. 14 is a diagram showing an example of a histogram of a first monochrome correction image and a second monochrome correction image in the fourth embodiment of the present invention.

FIG. 15 is a block diagram showing a configuration of an imaging apparatus according to a fifth embodiment of the present invention.

FIG. 16 is a block diagram showing a configuration of an imaging apparatus according to a sixth embodiment of the present invention.

FIG. 17 is a block diagram showing a configuration of an imaging apparatus according to a seventh embodiment of the present invention.

FIG. 18 is a block diagram showing a configuration of a measurement processing unit of the imaging apparatus according to the seventh embodiment of the present invention.

FIG. 19 is a block diagram showing a configuration of an imaging apparatus according to an eighth embodiment of the present invention.

FIG. 20 is a diagram showing image processing performed by a processed image generation unit in the eighth embodiment of the present invention.

FIG. 21 is a diagram showing an example of an image displayed in the eighth embodiment of the present invention.

FIG. 22 is a block diagram showing a configuration of an imaging apparatus according to a ninth embodiment of the present invention.

FIG. 23 is a diagram showing an example of an image displayed in the ninth embodiment of the present invention.

FIG. 24 is a diagram showing a captured image of a subject in white and black.

FIG. 25 is a diagram showing a line profile of a captured image of a subject in white and black.

FIG. 26 is a diagram showing a line profile of a captured image of a subject in white and black.

### DETAILED DESCRIPTION OF THE INVENTION

When an imaging apparatus disclosed in Japanese Unexamined Patent Application, First Publication No. 2013-044806 captures an image of a subject at a position away from the focusing position, color shift in an image occurs. The imaging apparatus including a pupil division optical system disclosed in Japanese Unexamined Patent Application, First Publication No. 2013-044806 approximates a shape and a centroid position of blur in an R image and a B image to a shape and a centroid position of blur in a G image so as to display an image in which double images due to color shift are suppressed.

In the imaging apparatus disclosed in Japanese Unexamined Patent Application, First Publication No. 2013-044806, correction of an R image and a B image is performed on the basis of a shape of blur in a G image. For this reason, the premise is that a waveform of a G image has no distortion (no double images). However, there are cases in which a waveform of a G image has distortion. Hereinafter, distortion of a waveform of a G image will be described with reference to FIGS. 24 to 26.

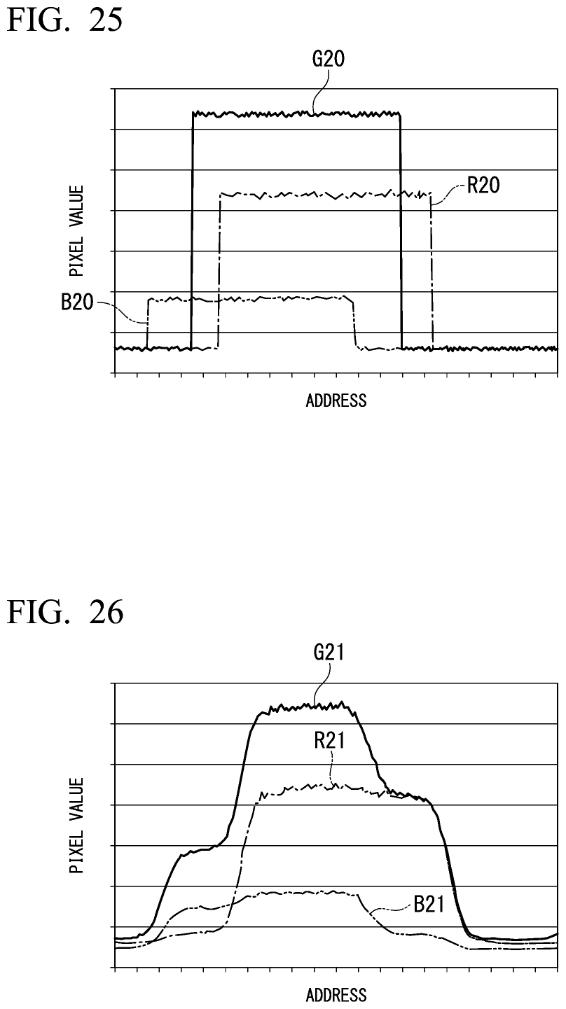

FIG. 24 shows a captured image I10 of a subject in black and white. FIGS. 25 and 26 show a profile of a line L10 in the captured image I10. The horizontal axis in FIGS. 25 and 26 represents an address of the captured image in the horizontal direction and the vertical axis represents a pixel value of the captured image. FIG. 25 shows a profile in a case where transmittance characteristics of color filters of respective colors do not overlap. FIG. 26 shows a profile in a case where transmittance characteristics of color filters of respective colors overlap. A profile R20 and a profile R21 are a profile of an R image. The R image includes information of pixels in which R color filters are disposed. A profile G20 and a profile G21 are a profile of a G image. The G image includes information of pixels in which G color filters are disposed. A profile B20 and a profile B21 are a profile of a B image. The B image includes information of pixels in which B color filters are disposed.

FIG. 25 shows that a waveform of the profile G20 of the G image has no distortion, but FIG. 26 shows that a waveform of the profile G21 of the G image has distortion. Since light transmitted through a G color filter includes components of R and B, distortion occurs in the waveform of the profile G21 of the G image. In the imaging apparatus disclosed in Japanese Unexamined Patent Application, First Publication No. 2013-044806, the profile G20 shown in FIG. 25 is the premise and the distortion of the waveform that occurs in the profile G21 shown in FIG. 26 is not the premise. For this reason, in a case where a shape and a centroid position of blur in the R image and the B image are corrected on the bases of the G image represented by the profile G21 shown in FIG. 26, the imaging apparatus displays an image including double images due to color shift.

There are cases in which a user performs pointing, i.e., designation of a point for an image that has been displayed. For example, in an industrial endoscope apparatus, it is possible to perform measurement on the basis of a measurement point designated by a user and perform inspection of damage and the like on the basis of the measurement result. However, when an image including the above-described double images is displayed, there are issues that it is hard for a user to perform pointing with high accuracy.

Hereinafter, embodiments of the present invention will be described with reference to the drawings.

### First Embodiment

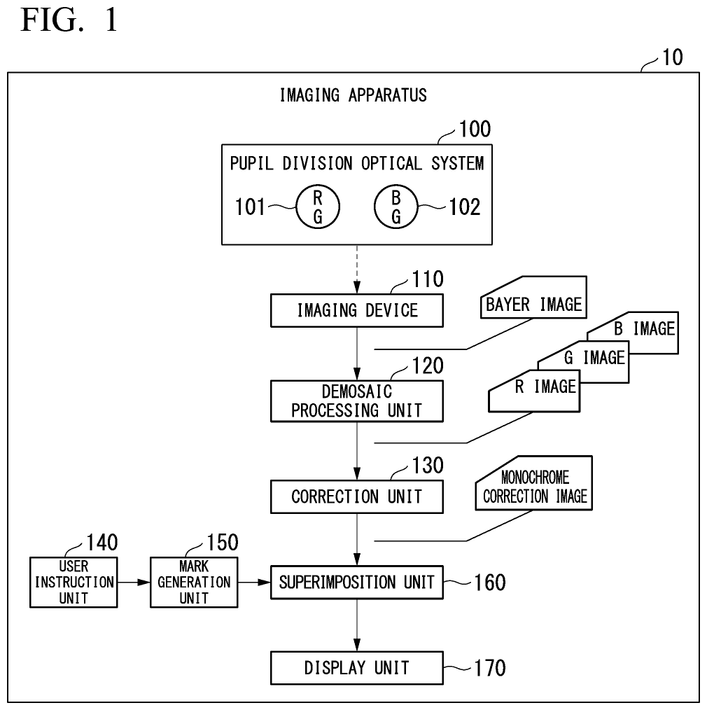

FIG. 1 shows a configuration of an imaging apparatus 10 according to a first embodiment of the present invention. The imaging apparatus 10 is a digital still camera, a video camera, a mobile phone with a camera, a mobile information terminal with a camera, a personal computer with a camera, a surveillance camera, an endoscope, a digital microscope, or the like. As shown in FIG. 1, the imaging apparatus 10 includes a pupil division optical system 100, an imaging device 110, a demosaic processing unit 120, a correction unit 130, a user instruction unit 140, a mark generation unit 150, a superimposition unit 160, and a display unit 170.

A schematic configuration of the imaging apparatus 10 will be described. The pupil division optical system 100 includes a first pupil 101 transmitting light of a first wavelength band and a second pupil 102 transmitting light of a second wavelength band different from the first wavelength band. The imaging device 110 captures an image of light transmitted through the pupil division optical system 100 and a first color filter having a first transmittance characteristic, captures an image of light transmitted through the pupil division optical system 100 and a second color filter having a second transmittance characteristic partially overlapping the first transmittance characteristic, and outputs a captured image. The correction unit 130 outputs at least one of a first monochrome correction image and a second monochrome correction image as a monochrome correction image. The first monochrome correction image is an image generated by correcting a value that is based on components overlapping between the first transmittance characteristic and the second transmittance characteristic for the captured image having components that are based on the first transmittance characteristic. The second monochrome correction image is an image generated by correcting a value that is based on components overlapping between the first transmittance characteristic and the second transmittance characteristic for the captured image having components that are based on the second transmittance characteristic. The user instruction unit 140 outputs point information that represents a point on the monochrome correction image in accordance with an instruction from a user. The mark generation unit 150 generates a mark. The superimposition unit 160 superimposes the mark on the monochrome correction image on the basis of the point information and outputs the monochrome correction image on which the mark is superimposed to the display unit 170. The display unit 170 displays the monochrome correction image on which the mark is superimposed.

A detailed configuration of the information imaging apparatus 10 will be described. The first pupil 101 of the pupil division optical system 100 includes an RG filter transmitting light of wavelengths of R (red) and G (green). The second pupil 102 of the pupil division optical system 100 includes a BG filter transmitting light of wavelengths of B (blue) and G (green).

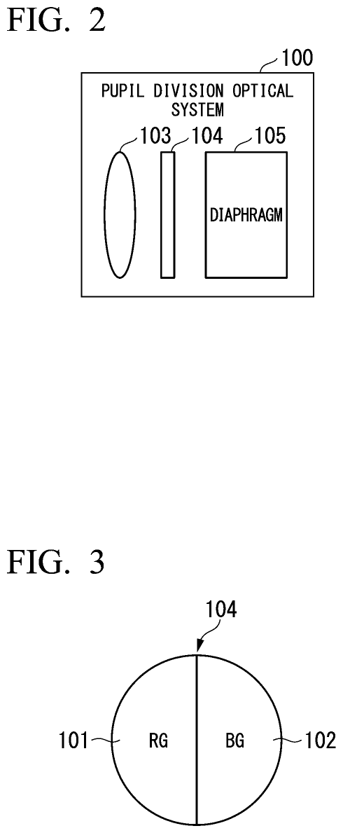

FIG. 2 shows a configuration of the pupil division optical system 100. As shown in FIG. 2, the pupil division optical system 100 includes a lens 103, a band limiting filter 104, and a diaphragm 105. For example, the lens 103 is typically constituted by a plurality of lenses in many cases. Only one lens is shown in FIG. 2 for brevity. The band limiting filter 104 is disposed on an optical path of light incident on the imaging device 110. For example, the band limiting filter 104 is disposed at the position of the diaphragm 105 or in the vicinity of the position. In the example shown in FIG. 2, the band limiting filter 104 is disposed between the lens 103 and the diaphragm 105. The diaphragm 105 adjusts brightness of light incident on the imaging device 110 by limiting the passing range of light that has passed through the lens 103.

FIG. 3 shows a configuration of the band limiting filter 104. In the example shown in FIG. 3, when the band limiting filter 104 is seen from the side of the imaging device 110, the left half of the band limiting filter 104 constitutes the first pupil 101 and the right half of the band limiting filter 104 constitutes the second pupil 102. The first pupil 101 transmits light of wavelengths of R and G, and blocks light of wavelengths of B. The second pupil 102 transmits light of wavelengths of B and G, and blocks light of wavelengths of R.

The imaging device 110 is a photoelectric conversion element such as a charge coupled device (CCD) sensor and a complementary metal oxide semiconductor (CMOS) sensor of the XY-address-scanning type. As a configuration of the imaging device 110, there is a type such as a single-plate-primary-color Bayer array and a three-plate type using three sensors. Hereinafter, an embodiment of the present invention will be described with reference to examples in which a CMOS sensor (500×500 pixels and depth of 10 bits) of the single-plate-primary-color Bayer array is used.

The imaging device 110 includes a plurality of pixels. In addition, the imaging device 110 includes color filters including a first color filter, a second color filter, and a third color filter. The color filters are disposed in each pixel of the imaging device 110. For example, the first color filter is an R filter, the second color filter is a B filter, and the third color filter is a G filter. Light transmitted through the pupil division optical system 100 and the color filters is incident on each pixel of the imaging device 110. Light transmitted through the pupil division optical system 100 contains light transmitted through the first pupil 101 and light transmitted through the second pupil 102. The imaging device 110 acquires and outputs a captured image including a pixel value of a first pixel on which light transmitted through the first color filter is incident, a pixel value of a second pixel on which light transmitted through the second color filter is incident, and a pixel value of a third pixel on which light transmitted through the third color filter is incident.

Analog front end (AFE) processing such as correlated double sampling (CDS), analog gain control (AGC), and analog-to-digital converter (ADC) is performed by the imaging device 110 on an analog captured image signal generated through photoelectric conversion in the CMOS sensor. A circuit outside the imaging device 110 may perform AFE processing. A captured image (Bayer image) acquired by the imaging device 110 is transferred to the demosaic processing unit 120.

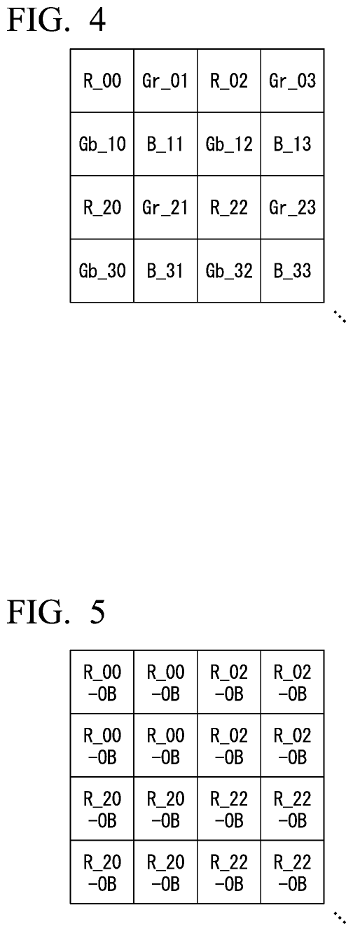

In the demosaic processing unit 120, a Bayer image is converted to an RGB image and a color image is generated. FIG. 4 shows a pixel arrangement of a Bayer image. R (red) and Gr (green) pixels are alternately disposed in odd rows and Gb (green) and B (blue) pixels are alternately disposed in even rows. R (red) and Gb (green) pixels are alternately disposed in odd columns and Gr (green) and B (blue) pixels are alternately disposed in even rows.

The demosaic processing unit 120 performs black-level correction (optical-black (OB) subtraction) on pixel values of a Bayer image. In addition, the demosaic processing unit 120 generates pixel values of adjacent pixels by copying pixel values of pixels. In this way, an RGB image having pixel values of each color in all the pixels is generated. For example, after the demosaic processing unit 120 performs OB subtraction on an R pixel value (R_00), the demosaic processing unit 120 copies a pixel value (R_00−OB). In this way, R pixel values in Gr, Gb, and B pixels adjacent to an R pixel are interpolated. FIG. 5 shows a pixel arrangement of an R image.

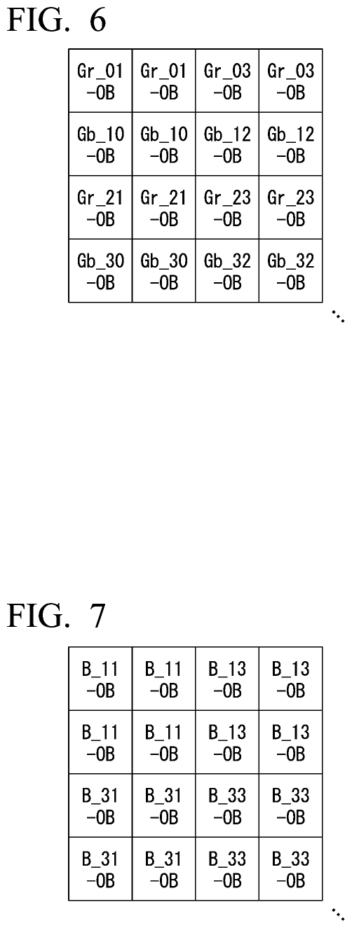

Similarly, after the demosaic processing unit 120 performs OB subtraction on a Gr pixel value (Gr_01), the demosaic processing unit 120 copies a pixel value (Gr_01−OB). In addition, after the demosaic processing unit 120 performs OB subtraction on a Gb pixel value (Gb_10), the demosaic processing unit 120 copies a pixel value (Gb_10−OB). In this way, G pixel values in an R pixel adjacent to a Gr pixel and in a B pixel adjacent to a Gb pixel are interpolated. FIG. 6 shows a pixel arrangement of a G image.

Similarly, after the demosaic processing unit 120 performs OB subtraction on a B pixel value (B_11), the demosaic processing unit 120 copies a pixel value (B_11−OB). In this way, B pixel values in R, Gr, and Gb pixels adjacent to a B pixel are interpolated. FIG. 7 shows a pixel arrangement of a B image.

The demosaic processing unit 120 generates a color image (RGB image) including an R image, a G image, and a B image through the above-described processing. A specific method of demosaic processing is not limited to the above-described method. Filtering processing may be performed on a generated RGB image. An RGB image generated by the demosaic processing unit 120 is transferred to the correction unit 130.

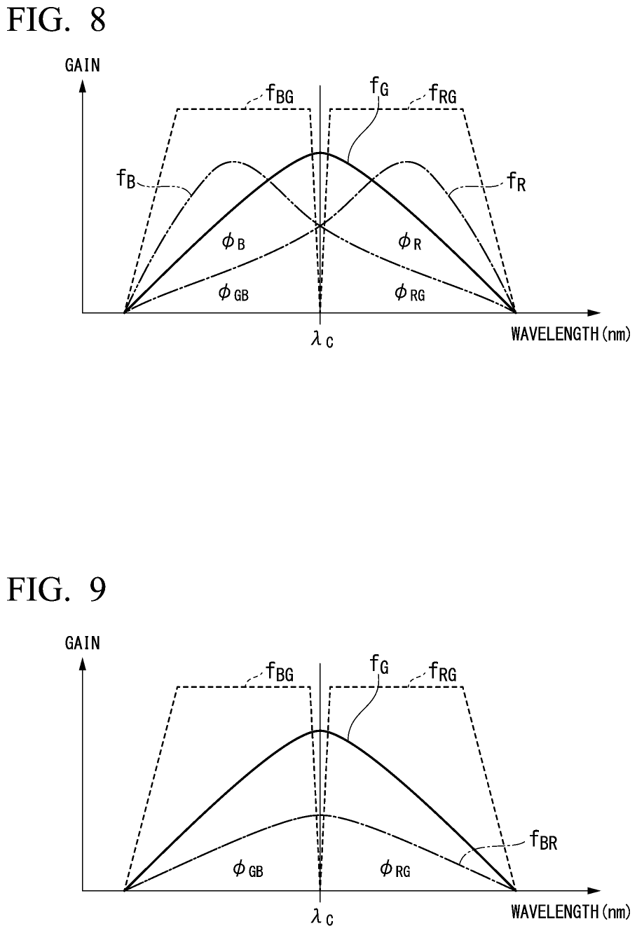

Details of processing performed by the correction unit 130 will be described. FIG. 8 shows an example of spectral characteristics (transmittance characteristics) of an RG filter of the first pupil 101, a BG filter of the second pupil 102, and color filters of the imaging device 110. The horizontal axis in FIG. 8 represents a wavelength λ [nm] and the vertical axis represents gain. A line f_{RG} represents spectral characteristics of the RG filter. A line f_{BG} represents spectral characteristics of the BG filter. A wavelength λ_{C} is the boundary between the spectral characteristics of the RG filter and the spectral characteristics of the BG filter. The RG filter transmits light of a wavelength band of longer wavelengths than the wavelength λ_{C}. The BG filter transmits light of a wavelength band of shorter wavelengths than the wavelength λ_{C}. A line f_{R} represents spectral characteristics (first spectral characteristics) of an R filter of the imaging device 110. A line f_{G} represents spectral characteristics of a G filter of the imaging device 110. Since the filtering characteristics of a Gr filter and a Gb filter are almost the same, the Gr filter and the Gb filter are shown as a G filter. A line f_{B} represents spectral characteristics (second spectral characteristics) of a B filter of the imaging device 110. Spectral characteristics of the filters of the imaging device 110 overlap.

An area between the line f_{R} and the line f_{B} in an area of longer wavelengths than the wavelength λ_{C} in the spectral characteristics shown by the line f_{R} is defined as an area φ_{R}. An area of longer wavelengths than the wavelength λ_{C} in the spectral characteristics shown by the line f_{B} is defined as an area φ_{RG}. An area between the line f_{B} and the line f_{R} in an area of shorter wavelengths than the wavelength λ_{C} in the spectral characteristics shown by the line f_{B} is defined as an area φ_{B}. An area of shorter wavelengths than the wavelength λ_{C} in the spectral characteristics shown by the line f_{R} is defined as an area φ_{GB}.

In a method in which a phase difference is acquired on the basis of an R image and a B image, for example, the difference between a phase of R (red) information and a phase of B (blue) information is acquired. R information is acquired through photoelectric conversion in R pixels of the imaging device 110 in which R filters are disposed. The R information includes information of the area φ_{B}, the area φ_{RG}, and the area φ_{GB} in FIG. 8. Information of the area φ_{R} and the area φ_{RG} is based on light transmitted through the RG filter of the first pupil 101. Information of the area φ_{GB} is based on light transmitted through the BG filter of the second pupil 102. Information of the area φ_{GB} in the R information is based on components overlapping between the spectral characteristics of the R filter and the spectral characteristics of the B filter. Since the area φ_{GB} is an area of the shorter wavelengths than the wavelength λ_{C}, the information of the area φ_{GB} is B information that causes double images due to color shift. Since this information causes distortion of a waveform of the R image and occurrence of double images, this information is undesirable for the R information.

On the other hand, B information is acquired through photoelectric conversion in B pixels of the imaging device 110 in which B filters are disposed. The B information includes information of the area φ_{B}, the area φ_{RG}, and the area φ_{GB} in FIG. 8. Information of the area φ_{B} and the area φ_{GB} is based on light transmitted through the BG filter of the second pupil 102. Information of the area φ_{RG} in the B information is based on components overlapping between the spectral characteristics of the B filter and the spectral characteristics of the R filter. Information of the area φ_{RG} is based on light transmitted through the RG filter of the first pupil 101. Since the area φ_{RG} is an area of the longer wavelengths than the wavelength λ_{C}, the information of the area φ_{RG} is R information that causes double images due to color shift. Since this information causes distortion of a waveform of the B image and occurrence of double images, this information is undesirable for the B information.

Correction is performed through which the information of the area φ_{GB} including blue information is reduced in red information and the information of the area φ_{RG} including red information is reduced in blue information. The correction unit 130 performs correction processing on the R image and the B image. In other words, the correction unit 130 reduces the information of the area φ_{GB} in red information and reduces the information of the area φ_{RG} in blue information.

FIG. 9 is a diagram similar to FIG. 8. In FIG. 9, a line f_{BR} represents the area φ_{GB} and the area φ_{RG} in FIG. 8. Spectral characteristics of the G filter shown by the line f_{G} and spectral characteristics shown by the line f_{BR} are typically similar. The correction unit 130 performs correction processing by using this feature. The correction unit 130 calculates red information and blue information by using Expression (1) and Expression (2) in the correction processing.

R′=R−α×G (1)

B′=B−β×G (2)

In Expression (1), R is red information before the correction processing is performed and R′ is red information after the correction processing is performed. In Expression (2), B is blue information before the correction processing is performed and B′ is blue information after the correction processing is performed. In this example, α and β are larger than 0 and smaller than 1. α and β are set in accordance with the spectral characteristics of the imaging device 110. In a case where the imaging apparatus 10 includes a light source for illumination, α and β are set in accordance with the spectral characteristics of the imaging device 110 and spectral characteristics of the light source. For example, α and β are stored in a memory not shown.

A value that is based on components overlapping between the spectral characteristics of the R filter and the spectral characteristics of the B filter is corrected through the operation shown in Expression (1) and Expression (2). The correction unit 130 generates an image (monochrome correction image) corrected as described above. The correction unit 130 outputs the monochrome correction image by outputting any one of a generated R′ image and a generated B′ image. For example, the correction unit 130 outputs the R′ image. In the first embodiment, any one of the R′ image and the B′ image is output to the display unit 170. The correction unit 130 may generate the R′ image and the B′ image and output only any one of the generated R′ image and the generated B′ image. Alternatively, the correction unit 130 may generate only predetermined one of the R′ image and the B′ image.

The superimposition unit 160 outputs the monochrome correction image output from the correction unit 130 to the display unit 170. The display unit 170 displays the monochrome correction image output from the superimposition unit 160.

The user instruction unit 140 is a user interface such as a button, a switch, a key, and a mouse. The user instruction unit 140 and the display unit 170 may be constituted as a touch panel. A user performs touch by a finger, click by a mouse, or the like for a position of interest on the monochrome correction image displayed on the display unit 170. In this way, a user performs pointing for the monochrome correction image through the user instruction unit 140. The user instruction unit 140 outputs point information of the position instructed by a user to the mark generation unit 150. For example, the point information is coordinate information like (x, y)=(200, 230). For example, a user performs pointing in order to mark a subject seen in the monochrome correction image. In a case where the imaging apparatus 10 is constituted as an endoscope apparatus, a user performs pointing in order to mark damage or the like seen in the monochrome correction image.

The mark generation unit 150 generates graphic data of a mark. The mark has an arbitrary shape and an arbitrary color. A user may designate a shape and a color of the mark. The mark generation unit 150 outputs the generated mark and the point information output from the user instruction unit 140 to the superimposition unit 160.

The superimposition unit 160 superimposes the mark on the monochrome correction image output from the correction unit 130. At this time, the superimposition unit 160 superimposes the mark on a position represented by the point information in the monochrome correction image. In this way, the mark is superimposed on a position at which a user has performed pointing. The monochrome correction image on which the mark has been superimposed is output to the display unit 170. The display unit 170 displays the monochrome correction image on which the mark has been superimposed. A user can confirm the position designated by the user in the monochrome correction image.

The point information may be directly output from the user instruction unit 140 to the superimposition unit 160. The mark generation unit 150 may generate an image having the same size as that of the monochrome correction image and on which the mark has been superimposed at a position represented by the point information. The image generated by the mark generation unit 150 is an image generated by superimposing the mark on a transparent image. The superimposition unit 160 may generate an image by overlapping the monochrome correction image output from the correction unit 130 and the image output from the mark generation unit 150.

High-quality image processing, i.e., γ correction, scaling processing, edge enhancement, and low-pass filtering processing may be performed on the monochrome correction image (R′ image) output from the correction unit 130. In scaling processing, bi-cubic, Nearest neighbor, and the like are used. In low-pass filtering processing, folding distortion (aliasing) is corrected. The correction unit 130 may perform these pieces of processing on the monochrome correction image. In other words, the correction unit 130 may generate a processed image by processing the monochrome correction image. Alternatively, the imaging apparatus 10 may include an image processing unit that performs these pieces of processing on the monochrome correction image. The superimposition unit 160 may output the processed image to the display unit 170. In addition, the superimposition unit 160 may superimpose the mark on a processed image generated by processing the monochrome correction image on the basis of the point information and output the processed image on which the mark has been superimposed to the display unit 170. The display unit 170 may display the processed image and the monochrome correction image on which the mark has been superimposed.

In a case where scaling processing is performed on the monochrome correction image, scaling information is notified to the mark generation unit 150 in order to match a position designated by a user and a position on which the mark is superimposed. For example, in a monochrome correction image (without scaling) having the size of 500×500, when a user designates the position of (x, y)=(200, 230) of the monochrome correction image, it is necessary to generate the mark at the position of (x, y)=(200, 230). On the other hand, when scaling is performed, it is necessary to convert a position designated by a user in accordance with the scaling. For example, when a monochrome correction image having the size of 500×500 is enlarged to have twice the size (1000×1000) of that, the coordinates of (x, y)=(200, 230) correspond to the position of (x, y)=(400, 460) in the processed image. For this reason, it is necessary to generate the mark at the coordinates.

The demosaic processing unit 120, the correction unit 130, the mark generation unit 150, and the superimposition unit 160 may be constituted by an application specific integrated circuit (ASIC), a field-programmable gate array (FPGA), a microprocessor, and the like. For example, the demosaic processing unit 120, the correction unit 130, the mark generation unit 150, and the superimposition unit 160 may be constituted by an ASIC and an embedded processor. The demosaic processing unit 120, the correction unit 130, the mark generation unit 150, and the superimposition unit 160 may be constituted by hardware, software, firmware, or combinations thereof other than the above.

The display unit 170 is a transparent type liquid crystal display (LCD) requiring backlight, a self-light-emitting type electro luminescence (EL) element (organic EL), and the like. For example, the display unit 170 is constituted as a transparent type LCD and includes a driving unit necessary for LCD driving. The driving unit generates a driving signal and drives an LCD by using the driving signal.

The imaging apparatus 10 may be an endoscope apparatus. In an industrial endoscope, the pupil division optical system 100 and the imaging device 110 are disposed at the distal end of an insertion unit that is to be inserted into the inside of an object for observation and measurement.

The imaging apparatus 10 according to the first embodiment includes the correction unit 130 and thus can suppress double images due to color shift of an image. In addition, since a monochrome correction image is displayed, visibility of an image can be improved. Even when a user observes an image in a method in which a phase difference is acquired on the basis of an R image and a B image, the user can observe an image in which double images due to color shift are suppressed and visibility is improved.

A user can observe a monochrome correction image or a processed image displayed on the display unit 170 and perform pointing on the image. Since the image in which double images due to color shift are suppressed is displayed, a user can easily perform pointing. In other words, a user can perform pointing with higher accuracy.

Since the display unit 170 displays a monochrome correction image, the amount of information output to the display unit 170 is reduced. For this reason, power consumption of the display unit 170 can be reduced.

### Second Embodiment

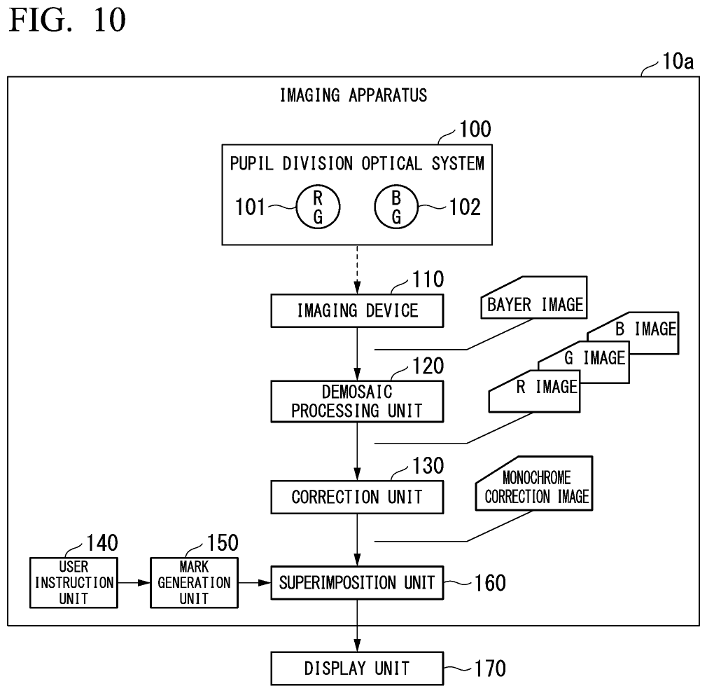

FIG. 10 shows a configuration of an imaging apparatus 10a according to a second embodiment of the present invention. In terms of the configuration shown in FIG. 10, differences from the configuration shown in FIG. 1 will be described.

The imaging apparatus 10a does not include the display unit 170. The display unit 170 is constituted independently of the imaging apparatus 10a. A monochrome correction image output from the correction unit 130 may be output to the display unit 170 via a communicator. For example, the communicator performs wired or wireless communication with the display unit 170.

In terms of points other than the above, the configuration shown in FIG. 10 is similar to the configuration shown in FIG. 1.

The imaging apparatus 10a according to the second embodiment can generate an image in which double images due to color shift are suppressed, visibility is improved, and pointing thereon is easier as with the imaging apparatus 10 according to the first embodiment. Since the display unit 170 is independent of the imaging apparatus 10a, the imaging apparatus 10a can be miniaturized. In addition, by transferring a monochrome correction image, the frame rate when an image is transferred to the display unit 170 increases and the bit rate is reduced compared to a color image.

### Third Embodiment

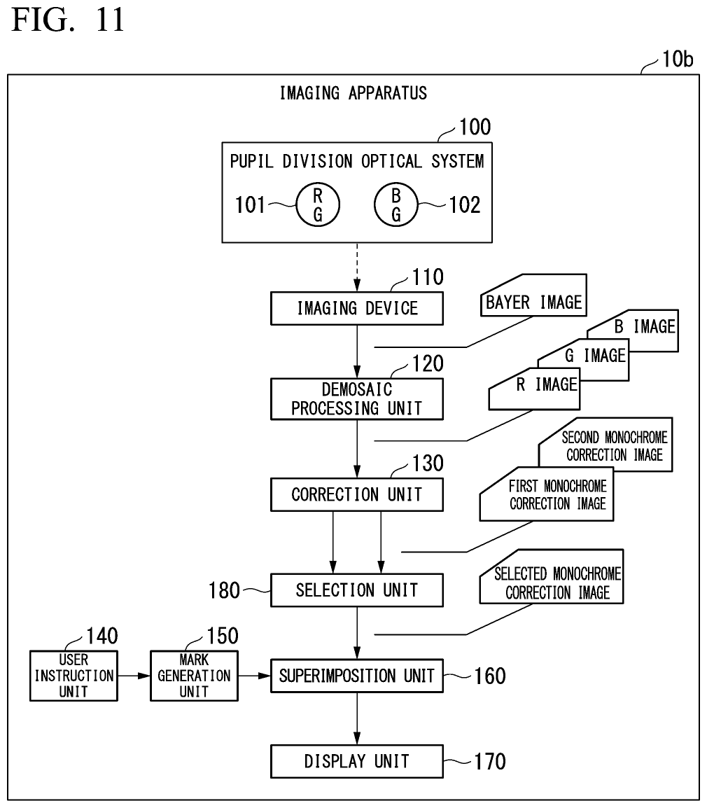

FIG. 11 shows a configuration of an imaging apparatus 10b according to a third embodiment of the present invention. In terms of the configuration shown in FIG. 11, differences from the configuration shown in FIG. 1 will be described.

The imaging apparatus 10b includes a selection unit 180 in addition to the configuration of the imaging apparatus 10 shown in FIG. 1. The correction unit 130 outputs a first monochrome correction image and a second monochrome correction image. As described above, the first monochrome correction image is an image generated by correcting a value that is based on components overlapping between a first transmittance characteristic and a second transmittance characteristic for a captured image having components that are based on the first transmittance characteristic. The second monochrome correction image is an image generated by correcting a value that is based on components overlapping between the first transmittance characteristic and the second transmittance characteristic for the captured image having components that are based on the second transmittance characteristic. The selection unit 180 selects at least one of the first monochrome correction image and the second monochrome correction image output from the correction unit 130 and outputs the selected image as a selected monochrome correction image. For example, the first monochrome correction image is an R′ image. For example, the second monochrome correction image is a B′ image. The selection unit 180 is constituted by an ASIC, an FPGA, a microprocessor, and the like.

In terms of points other than the above, the configuration shown in FIG. 11 is similar to the configuration shown in FIG. 1.

The imaging apparatus 10b according to the third embodiment can generate an image in which double images due to color shift are suppressed, visibility is improved, and pointing thereon is easier as with the imaging apparatus 10 according to the first embodiment.

### Fourth Embodiment

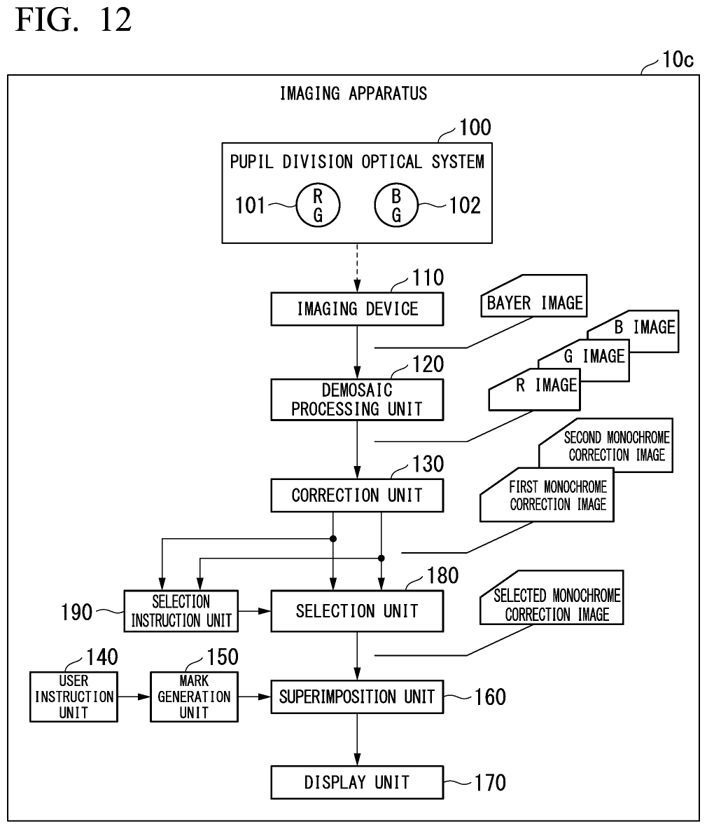

FIG. 12 shows a configuration of an imaging apparatus 10c according to a fourth embodiment of the present invention. In terms of the configuration shown in FIG. 12, differences from the configuration shown in FIG. 11 will be described.

The imaging apparatus 10c includes a selection instruction unit 190 in addition to the configuration of the imaging apparatus 10b shown in FIG. 11. The selection instruction unit 190 instructs the selection unit 180 to select at least one of a first monochrome correction image and a second monochrome correction image. The selection unit 180 selects at least one of the first monochrome correction image and the second monochrome correction image in accordance with an instruction from the selection instruction unit 190.

The selection instruction unit 190 instructs the selection unit 180 to select an image having a higher signal-to-noise ratio (SNR) out of the first monochrome correction image and the second monochrome correction image. For example, the selection instruction unit 190 instructs the selection unit 180 to select one of the first monochrome correction image and the second monochrome correction image in accordance with a result of analyzing the first monochrome correction image and the second monochrome correction image. In an example described below, the selection instruction unit 190 instructs the selection unit 180 to select one of the first monochrome correction image and the second monochrome correction image in accordance with a histogram of the first monochrome correction image and the second monochrome correction image. The selection instruction unit 190 is constituted by an ASIC, an FPGA, a microprocessor, and the like.

In terms of points other than the above, the configuration shown in FIG. 12 is similar to the configuration shown in FIG. 11.

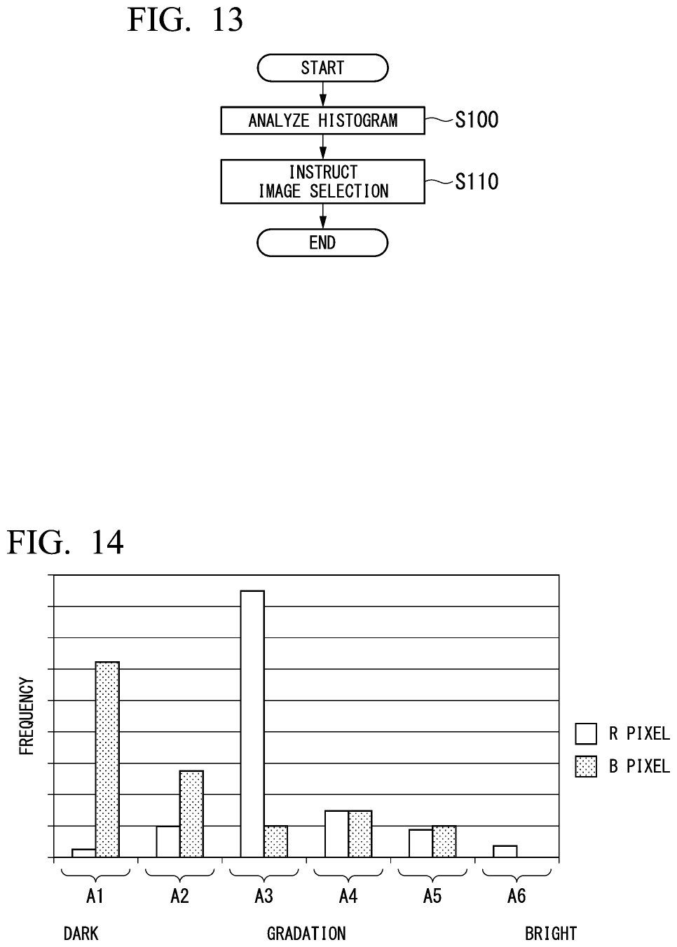

FIG. 13 shows a procedure of an operation of the selection instruction unit 190. The first monochrome correction image and the second monochrome correction image generated by the correction unit 130 is input to the selection instruction unit 190. The selection instruction unit 190 analyzes a histogram of the first monochrome correction image and the second monochrome correction image (step S100). After step S100, the selection instruction unit 190 instructs the selection unit 180 to select a monochrome correction image determined through histogram analysis (step S110).

Details of processing in step S100 will be described. The selection instruction unit 190 generates a histogram of pixel values of pixels in the first monochrome correction image and the second monochrome correction image. FIG. 14 shows an example of a histogram of the first monochrome correction image and the second monochrome correction image. The horizontal axis in FIG. 14 represents gradation of a pixel value and the vertical axis in FIG. 14 represents a frequency. In FIG. 14, a histogram of pixel values of a plurality of R pixels in an R′ image that is a first monochrome correction image and a histogram of pixel values of a plurality of B pixels in a B′ image that is a second monochrome correction image are shown. 10 bits of depth (0 to 1023) of the imaging device 110 are classified as an area A1 to an area A6. The area A1 is an area that corresponds to pixel values of 0 to 169. An area A2 is an area that corresponds to pixel values of 170 to 339. An area A3 is an area that corresponds to pixel values of 340 to 509. An area A4 is an area that corresponds to pixel values of 510 to 679. An area A5 is an area that corresponds to pixel values of 680 to 849. The area A6 is an area that corresponds to pixel values of 850 to 1023. Pixels having a pixel value of an area on the more left side are dark and pixels having a pixel value of an area on the more right side are bright. In the example shown in FIG. 14, frequencies of R pixels are distributed in brighter areas compared to frequencies of B pixels. For this reason, it can be determined that an R′ image has a higher SNR than a B′ image. The selection instruction unit 190 determines that a monochrome correction image to be selected by the selection unit 180 is an R′ image.

In this example, the selection instruction unit 190 generates a histogram of pixel values of a plurality of R pixels and a histogram of pixel values of a plurality of B pixels. The selection instruction unit 190 instructs the selection unit 180 to select a monochrome correction image corresponding to pixels with higher frequencies of larger pixel values out of R pixels and B pixels. The selection instruction unit 190 may use a captured image, i.e., a Bayer image instead of a first monochrome correction image and a second monochrome correction image. For example, the selection instruction unit 190 generates a histogram of pixel values of a plurality of R pixels in a Bayer image and a histogram of pixel values of a plurality of B pixels in the Bayer image. The selection instruction unit 190 performs processing similar to the above on the basis of each of the histograms. In addition, the display unit 170 may be constituted independently of the imaging apparatus 10c.

The imaging apparatus 10c according to the fourth embodiment can generate an image in which double images due to color shift are suppressed, visibility is improved, and pointing thereon is easier as with the imaging apparatus 10 according to the first embodiment.

The selection instruction unit 190 instructs the selection unit 180 to select an image having a higher SNR out of a first monochrome correction image and a second monochrome correction image. Since a monochrome correction image having a higher SNR is displayed, a user can perform pointing more easily.

### Fifth Embodiment

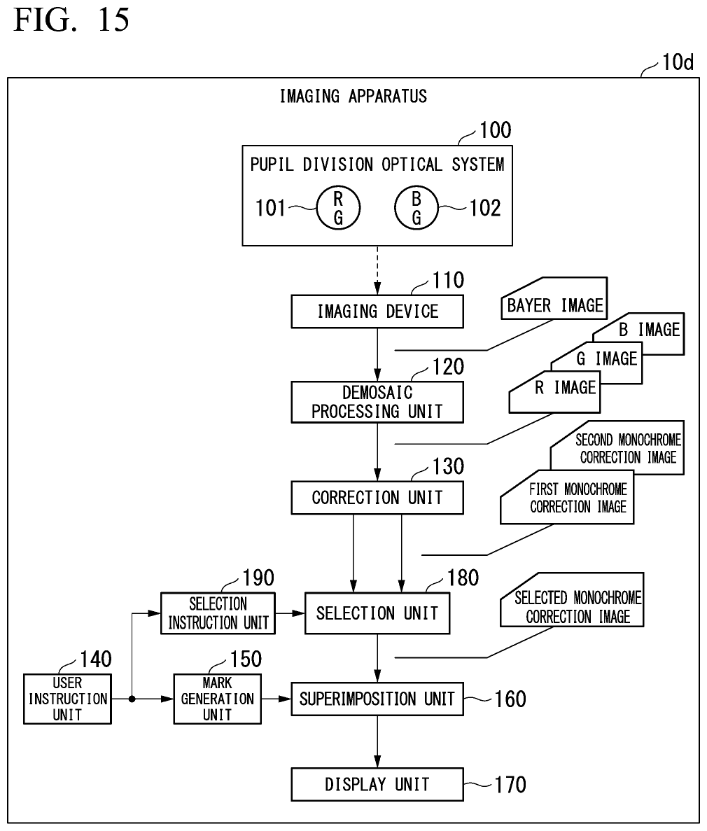

FIG. 15 shows a configuration of an imaging apparatus 10d according to a fifth embodiment of the present invention. In terms of the configuration shown in FIG. 15, differences from the configuration shown in FIG. 12 will be described.

The selection instruction unit 190 instructs the selection unit 180 to select at least one of a first monochrome correction image and a second monochrome correction image in accordance with an instruction from a user. The user instruction unit 140 accepts an instruction from a user. A user inputs an instruction for selecting at least one of a first monochrome correction image and a second monochrome correction image through the user instruction unit 140. The user instruction unit 140 outputs information of an image instructed by a user out of a first monochrome correction image and a second monochrome correction image to the selection instruction unit 190. The selection instruction unit 190 instructs the selection unit 180 to select the image represented by the information output from the user instruction unit 140.

In terms of points other than the above, the configuration shown in FIG. 15 is similar to the configuration shown in FIG. 12.

The display unit 170 may be constituted independently of the imaging apparatus 10d.

The imaging apparatus 10d according to the fifth embodiment can generate an image in which double images due to color shift are suppressed, visibility is improved, and pointing thereon is easier as with the imaging apparatus 10 according to the first embodiment.

The selection instruction unit 190 instructs the selection unit 180 to select an image instructed by a user out of a first monochrome correction image and a second monochrome correction image. For this reason, a user can perform pointing for an image that the user favors.

### Sixth Embodiment

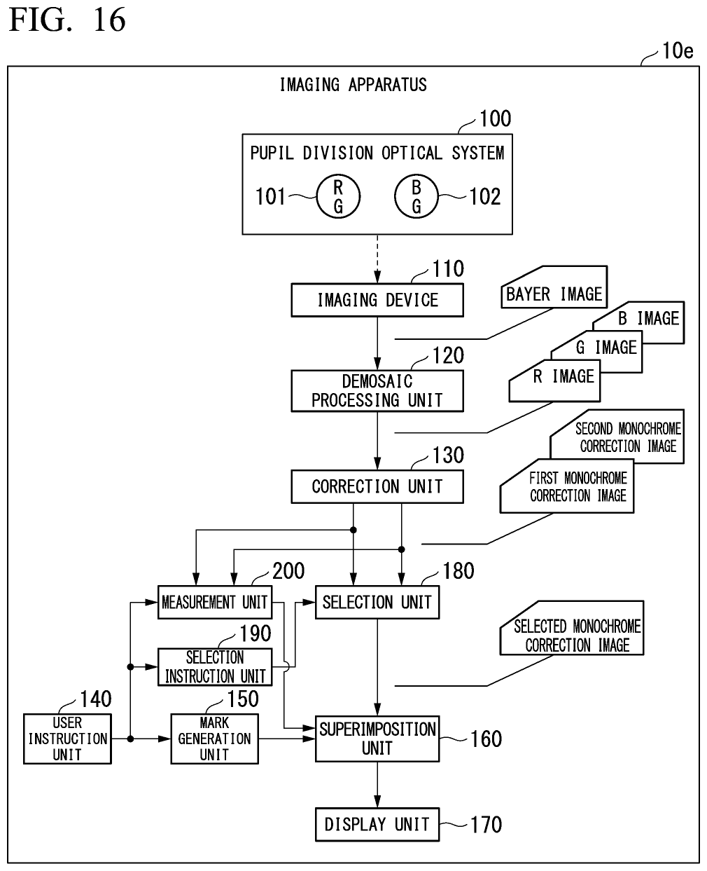

FIG. 16 shows a configuration of an imaging apparatus 10e according to a sixth embodiment of the present invention. In terms of the configuration shown in FIG. 16, differences from the configuration shown in FIG. 15 will be described.

The imaging apparatus 10e includes a measurement unit 200 in addition to the configuration of the imaging apparatus 10d shown in FIG. 15. A first monochrome correction image and a second monochrome correction image generated by the correction unit 130 are input to the measurement unit 200. In addition, point information output from the user instruction unit 140 is input to the measurement unit 200. The measurement unit 200 calculates a phase difference between the first monochrome correction image and the second monochrome correction image. The point information output from the user instruction unit 140 represents a measurement point that is a position at which a phase difference is calculated. The measurement unit 200 calculates a phase difference at the measurement point represented by the point information.

The measurement unit 200 calculates a distance of a subject on the basis of a phase difference. For example, when one arbitrary point on an image is designated by a user, the measurement unit 200 performs measurement of depth. When two arbitrary points on an image are designated by a user, the measurement unit 200 can measure the distance between the two points. The measurement unit 200 outputs a measurement result as character information of a measurement value to the superimposition unit 160. The measurement unit 200 is constituted by an ASIC, an FPGA, a microprocessor, and the like.

The superimposition unit 160 superimposes the character information of the measurement value on a selected monochrome correction image and outputs the selected monochrome correction image on which the character information of the measurement value has been superimposed to the display unit 170. The display unit 170 displays the selected monochrome correction image on which the character information of the measurement value has been superimposed. For this reason, a user can confirm a measurement result.

In terms of points other than the above, the configuration shown in FIG. 16 is similar to the configuration shown in FIG. 15.

The display unit 170 may be constituted independently of the imaging apparatus 10e. The selection instruction unit 190 may instruct the selection unit 180 to select an image having a higher SNR out of a first monochrome correction image and a second monochrome correction image as with the fourth embodiment.

The imaging apparatus 10e according to the sixth embodiment can generate an image in which double images due to color shift are suppressed, visibility is improved, and pointing thereon is easier as with the imaging apparatus 10 according to the first embodiment. A user can designate a measurement point with higher accuracy for an image whose visibility has been improved.

### Seventh Embodiment

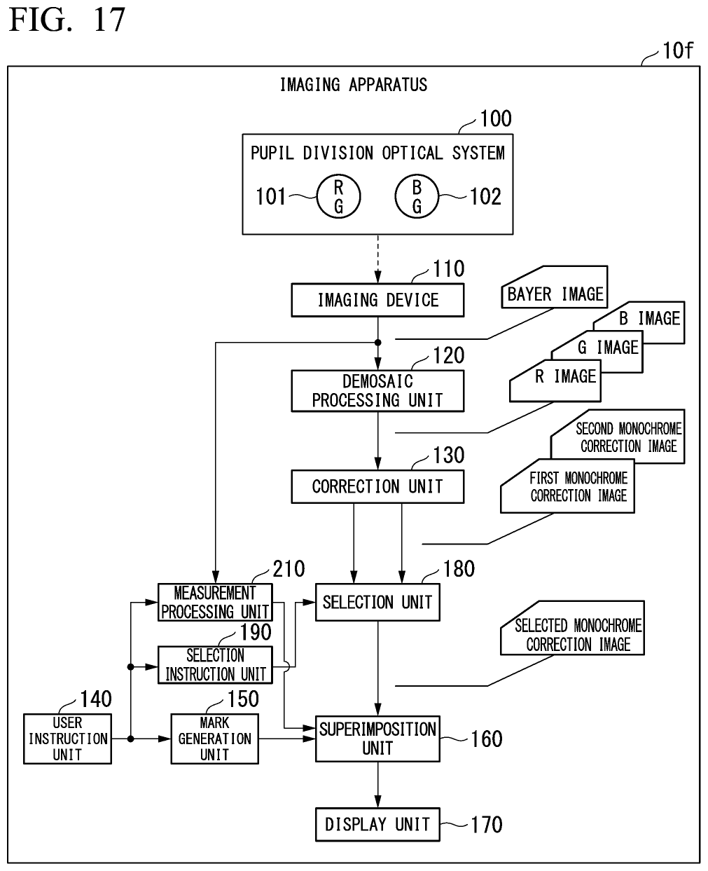

FIG. 17 shows a configuration of an imaging apparatus 10f according to a seventh embodiment of the present invention. In terms of the configuration shown in FIG. 17, differences from the configuration shown in FIG. 16 will be described.

In the imaging apparatus 10f, the measurement unit 200 in the imaging apparatus 10e shown in FIG. 16 is changed to a measurement processing unit 210. A Bayer image output from the imaging device 110 is input to the measurement processing unit 210. In addition, point information output from the user instruction unit 140 is input to the measurement processing unit 210. The measurement processing unit 210 outputs character information of a measurement value to the superimposition unit 160.

In terms of points other than the above, the configuration shown in FIG. 17 is similar to the configuration shown in FIG. 16.

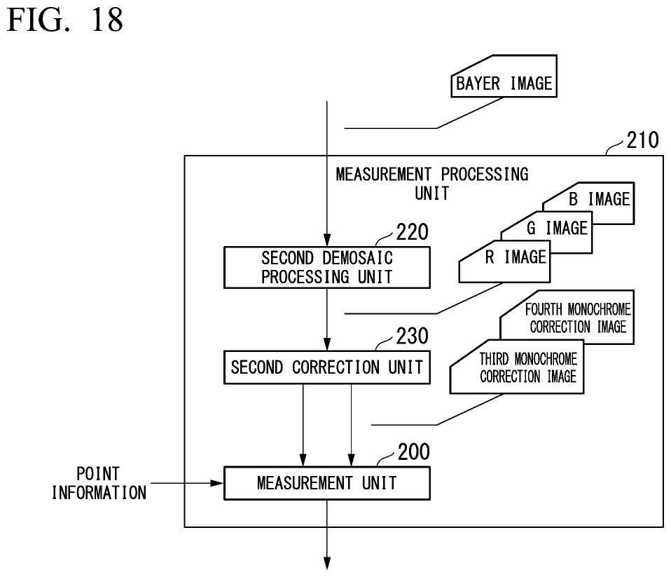

FIG. 18 shows a configuration of a measurement processing unit 210. As shown in FIG. 18, the measurement processing unit 210 includes a second demosaic processing unit 220, a second correction unit 230, and a measurement unit 200.

A Bayer image output from the imaging device 110 is input to the second demosaic processing unit 220. The second demosaic processing unit 220 generates pixel values of adjacent pixels by copying pixel values of pixels. In this way, an RGB image having pixel values of each color in all the pixels is generated. The RGB image includes an R image, a G image, and a B image. The second demosaic processing unit 220 in the seventh embodiment does not perform OB subtraction, but may perform OB subtraction. In a case where the second demosaic processing unit 220 performs OB subtraction, an OB subtraction value may be different from the OB subtraction value used by the demosaic processing unit 120. The second demosaic processing unit 220 outputs the generated RGB image to the second correction unit 230.

The second correction unit 230 is disposed independently of the correction unit 130. The second correction unit 230 generates a third monochrome correction image and a fourth monochrome correction image. The third monochrome correction image is an image generated by correcting a value that is based on components overlapping between a first transmittance characteristic and a second transmittance characteristic for a captured image having components that are based on the first transmittance characteristic. The fourth monochrome correction image is an image generated by correcting a value that is based on components overlapping between the first transmittance characteristic and the second transmittance characteristic for the captured image having components that are based on the second transmittance characteristic. The second correction unit 230 outputs the generated third monochrome correction image and the generated fourth monochrome correction image to the measurement unit 200. The measurement unit 200 calculates a phase difference between the third monochrome correction image and the fourth monochrome correction image.

Specifically, the second correction unit 230 performs correction processing on the R image and the B image. The correction processing performed by the second correction unit 230 is similar to the correction processing performed by the correction unit 130. The second correction unit 230 reduces information of the area φ_{GB} in FIG. 8 in red information and reduces information of the area φ_{RG} in FIG. 8 in blue information. In this way, an R′ image that is the third monochrome correction image is generated and a B′ image that is the fourth monochrome correction image is generated.

The measurement unit 200 is constituted similarly to the measurement unit 200 in the imaging apparatus 10e shown in FIG. 16. The second demosaic processing unit 220 and the second correction unit 230 are constituted by an ASIC, an FPGA, a microprocessor, and the like.

The display unit 170 may be constituted independently of the imaging apparatus 10f. The selection instruction unit 190 may instruct the selection unit 180 to select an image having a higher SNR out of a first monochrome correction image and a second monochrome correction image as with the fourth embodiment.

The imaging apparatus 10f according to the seventh embodiment can generate an image in which double images due to color shift are suppressed, visibility is improved, and pointing thereon is easier as with the imaging apparatus 10 according to the first embodiment. A user can designate a measurement point with higher accuracy for an image whose visibility has been improved.

The second demosaic processing unit 220 sets an OB subtraction value (zero in the above-described example) in accordance with measurement processing performed by the measurement unit 200. For this reason, OB subtraction suitable for measurement can be performed and measurement accuracy is improved. In addition, the demosaic processing unit 120 sets an OB subtraction value in accordance with a black level. For this reason, a suitable black level can be set and image quality is improved.

### Eighth Embodiment

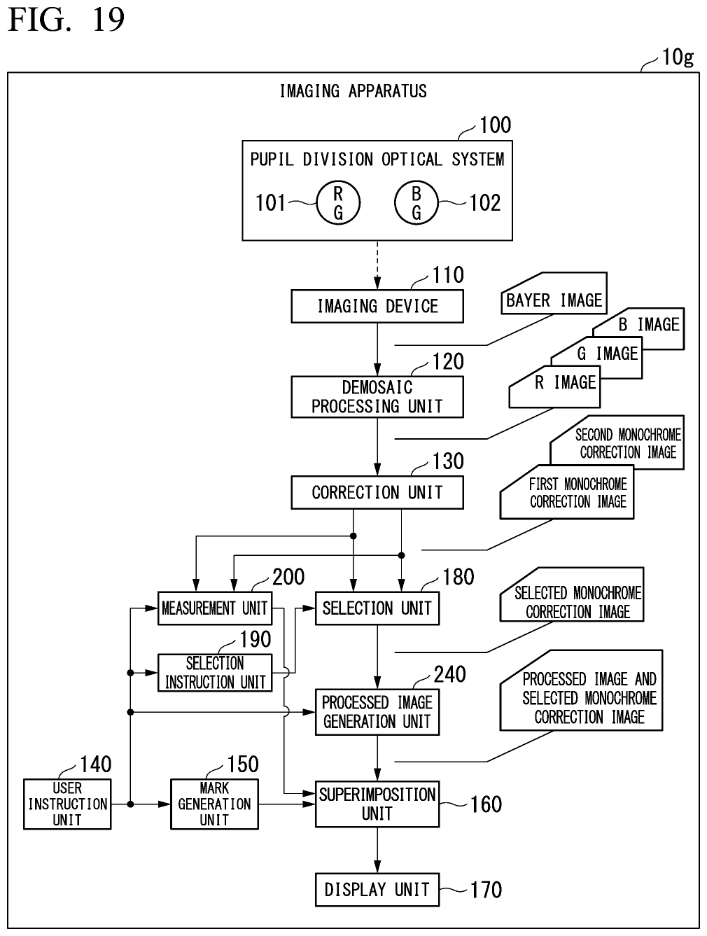

FIG. 19 shows a configuration of an imaging apparatus 10g according to an eighth embodiment of the present invention. In terms of the configuration shown in FIG. 19, differences from the configuration shown in FIG. 16 will be described.

The imaging apparatus 10g includes a processed image generation unit 240 in addition to the configuration of the imaging apparatus 10e shown in FIG. 16. The user instruction unit 140 designates at least one mode included in a plurality of modes in accordance with an instruction from a user. A selected monochrome correction image selected by the selection unit 180 is input to the processed image generation unit 240. The processed image generation unit 240 generates a processed image by performing image processing corresponding to the mode designated by the user instruction unit 140 on at least part of the selected monochrome correction image output from the selection unit 180. The processed image generation unit 240 performs image processing on at least part of the selected monochrome correction image. The processed image generation unit 240 outputs the generated processed image and the selected monochrome correction image output from the selection unit 180 to the superimposition unit 160.

The processed image generation unit 240 constitutes an image processing unit. The processed image generation unit 240 is constituted by an ASIC, an FPGA, a microprocessor, and the like. The processed image generation unit 240 generates a processed image by performing at least one of enlargement processing, edge extraction processing, edge enhancement processing, and noise reduction processing on at least part of the monochrome correction image output from the selection unit 180. The processed image generation unit 240 may generate a processed image by performing enlargement processing and at least one of edge extraction processing, edge enhancement processing, and noise reduction processing on at least part of the monochrome correction image output from the selection unit 180.

The superimposition unit 160 superimposes a processed image on the selected monochrome correction image if necessary and outputs the selected monochrome correction image on which the processed image is superimposed to the display unit 170. The processed image may be directly output from the processed image generation unit 240 to the display unit 170.

In terms of points other than the above, the configuration shown in FIG. 19 is similar to the configuration shown in FIG. 16.

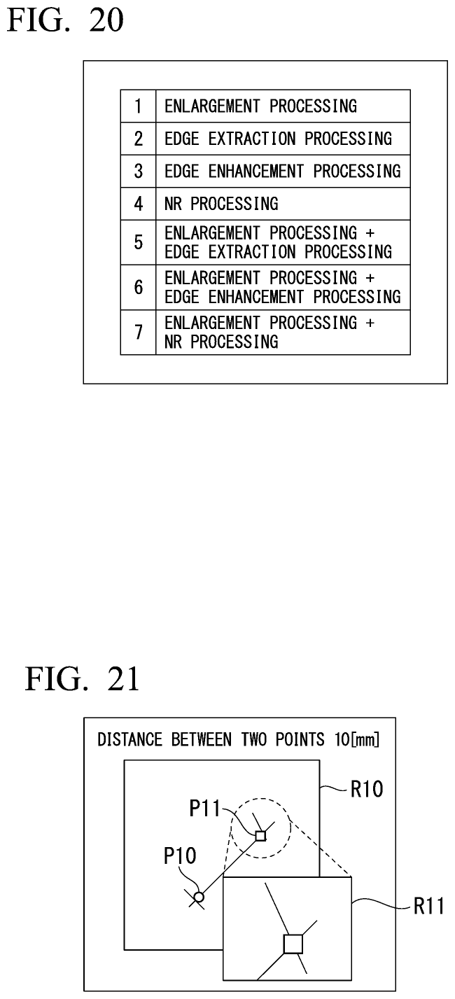

FIG. 20 shows image processing performed by the processed image generation unit 240. In FIG. 20, seven image processing methods are shown. The first method is enlargement processing. The second method is edge extraction processing. The third method is edge enhancement processing. The fourth method is noise reduction (NR) processing. The fifth method is a combination of the enlargement processing and the edge extraction processing. The sixth method is a combination of the enlargement processing and the edge enhancement processing. The seventh method is a combination of the enlargement processing and the NR processing.

For example, the seven image processing methods shown in FIG. 20 are displayed on the display unit 170. A user designates a desired image processing method by touching a screen of the display unit 170 or the like. The user instruction unit 140 outputs information that represents the image processing method instructed by a user to the processed image generation unit 240. The processed image generation unit 240 processes the selected monochrome correction image through the image processing method instructed by a user.

FIG. 21 shows an example of an image displayed on the display unit 170. For example, an R′ image R10 is displayed. A user designates a measurement point for the R′ image R10. In FIG. 21, the state when a measurement point P11 is designated after a measurement point P10 is designated is shown. When the measurement point P11 is designated, a processed image R11 is generated by enlarging a predetermined area including a position at which a user intends to designate as the measurement point P11 in the R′ image R10. The processed image R11 is superimposed and displayed on the R′ image R10. Since the area around the position at which a user intends to designate as the measurement point P11 is enlarged, the user can easily designate the measurement point P11 and can easily confirm the position of the designated measurement point P11 in the processed image R11. The distance (10 [mm]) between two points on a subject corresponding to the measurement point P10 and the measurement point P11 is displayed as a measurement result on the display unit 170.

In FIG. 21, the display unit 170 displays the R′ image R10 and the processed image R11 such that part of the R′ image R10 and part of the processed image R11 overlap. The display unit 170 may arrange and display the R′ image R10 and the processed image R11 such that the R′ image R10 and the processed image R11 do not overlap.

The display unit 170 may be constituted independently of the imaging apparatus 10g. The selection instruction unit 190 may instruct the selection unit 180 to select an image having a higher SNR out of a first monochrome correction image and a second monochrome correction image as with the fourth embodiment.

The imaging apparatus 10g according to the eighth embodiment can generate an image in which double images due to color shift are suppressed, visibility is improved, and pointing thereon is easier as with the imaging apparatus 10 according to the first embodiment. Since a processed image is displayed, a user can designate a measurement point with higher accuracy.

### Ninth Embodiment

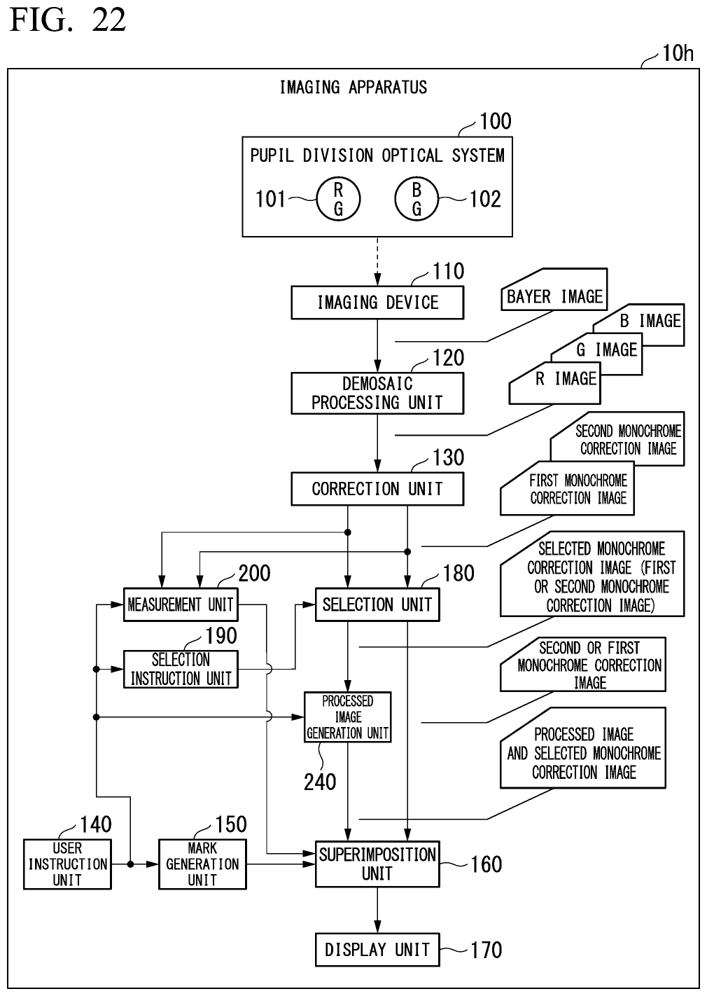

FIG. 22 shows a configuration of an imaging apparatus 10h according to a ninth embodiment of the present invention. In terms of the configuration shown in FIG. 22, differences from the configuration shown in FIG. 19 will be described.

The selection unit 180 outputs an image selected as a selected monochrome correction image out of a first monochrome correction image and a second monochrome correction image to the processed image generation unit 240. In addition, the selection unit 180 outputs an image not selected as the selected monochrome correction image out of the first monochrome correction image and the second monochrome correction image to the superimposition unit 160. When the selection unit 180 selects the first monochrome correction image as the selected monochrome correction image, the second monochrome correction image is output from the selection unit 180 to the superimposition unit 160. When the selection unit 180 selects the second monochrome correction image as the selected monochrome correction image, the first monochrome correction image is output from the selection unit 180 to the superimposition unit 160.

The superimposition unit 160 superimposes a processed image on the selected monochrome correction image. In addition, the superimposition unit 160 generates an image in which the selected monochrome correction image on which the processed image is superimposed and the monochrome correction image output from the selection unit 180 are arranged, and outputs the generated image to the display unit 170. The display unit 170 arranges and displays the selected monochrome correction image on which the processed image is superimposed and the monochrome correction image.

In terms of points other than the above, the configuration shown in FIG. 22 is similar to the configuration shown in FIG. 19.

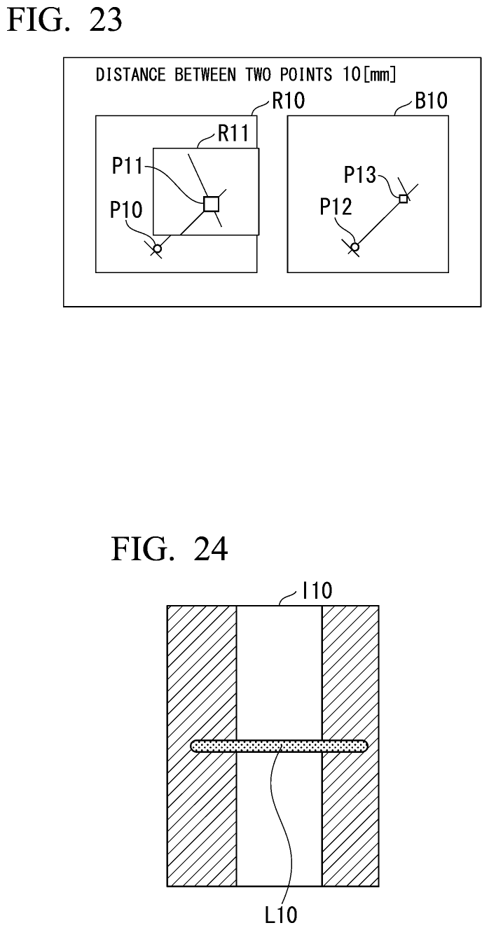

FIG. 23 shows an example of an image displayed on the display unit 170. As with FIG. 21, an R′ image R10 on which a processed image R11 has been superimposed is displayed. In addition, a B′ image B10 not selected as a selected monochrome correction image by the selection unit 180 is displayed. For example, a user designates a measurement point for the R′ image R10 having a high SNR. A measurement point P10 designated by a user is superimposed and displayed on the R′ image R10, and a measurement point P11 designated by the user is superimposed and displayed on the processed image R11. In addition, the distance (10 [mm]) between two points on a subject corresponding to the measurement point P10 and the measurement point P11 is displayed as a measurement result. Further, a point P12 corresponding to the measurement point P10 and a point P13 corresponding to the measurement point P11 are superimposed and displayed on the B′ image B10. A user can determine measurement accuracy by confirming the point P12 and the point P13.

The display unit 170 may be constituted independently of the imaging apparatus 10h. The selection instruction unit 190 may instruct the selection unit 180 to select an image having a higher SNR out of a first monochrome correction image and a second monochrome correction image as with the fourth embodiment. The processed image generation unit 240 may perform image processing on a selected monochrome correction image and an image not selected as the selected monochrome correction image by the selection unit 180.

The imaging apparatus 10h according to the ninth embodiment can generate an image in which double images due to color shift are suppressed, visibility is improved, and pointing thereon is easier as with the imaging apparatus 10 according to the first embodiment. Since two monochrome correction images are displayed, a user can confirm a result of designating a measurement point.

While preferred embodiments of the invention have been described and shown above, it should be understood that these are examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An imaging apparatus comprising:
a pupil division optical system including a first pupil transmitting light of a first wavelength band and a second pupil transmitting light of a second wavelength band different from the first wavelength band;
an imaging device configured to capture an image of light transmitted through the pupil division optical system and a first color filter having a first transmittance characteristic and light transmitted through the pupil division optical system and a second color filter having a second transmittance characteristic partially overlapping the first transmittance characteristic, and output the captured image; and
a processor configured to:
generate at least one of a first monochrome correction image and a second monochrome correction image as a monochrome correction image, the first monochrome correction image being an image generated by correcting a value that is based on components overlapping between the first transmittance characteristic and the second transmittance characteristic for the captured image having components that are based on the first transmittance characteristic, the second monochrome correction image being an image generated by correcting a value that is based on components overlapping between the first transmittance characteristic and the second transmittance characteristic for the captured image having components that are based on the second transmittance characteristic;
generate point information that represents a point on the monochrome correction image in accordance with an instruction from a user;
generate a mark; and
superimpose the mark on the monochrome correction image or a processed image generated by processing the monochrome correction image on the basis of the point information and output the monochrome correction image or the processed image on which the mark is superimposed to a display unit.

2. The imaging apparatus according to claim 1,
wherein the processor is configured to:
generate the first monochrome correction image and the second monochrome correction image;
select at least one of the first monochrome correction image and the second monochrome correction image; and
output the selected image as the monochrome correction image.

3. The imaging apparatus according to claim 2,
wherein the processor is configured to select an image having a higher signal-to-noise ratio (SNR) out of the first monochrome correction image and the second monochrome correction image.

4. The imaging apparatus according to claim 2,
wherein the processor is configured to select at least one of the first monochrome correction image and the second monochrome correction image in accordance with an instruction from a user.

5. The imaging apparatus according to claim 2,
wherein the processor is configured to calculate a phase difference between the first monochrome correction image and the second monochrome correction image, and
the point information represents a measurement point that is a position at which the phase difference is calculated.

6. The imaging apparatus according to claim 2,
wherein the processor is configured to:
generate a third monochrome correction image and a fourth monochrome correction image, the third monochrome correction image being an image generated by correcting a value that is based on components overlapping between the first transmittance characteristic and the second transmittance characteristic for the captured image having components that are based on the first transmittance characteristic, the fourth monochrome correction image being an image generated by correcting a value that is based on components overlapping between the first transmittance characteristic and the second transmittance characteristic for the captured image having components that are based on the second transmittance characteristic; and
calculate a phase difference between the third monochrome correction image and the fourth monochrome correction image, and
the point information represents a measurement point that is a position at which the phase difference is calculated.

7. The imaging apparatus according to claim 2,
wherein the processor is configured to:
designate at least one mode included in a plurality of modes in accordance with an instruction from a user; and
generate a processed image by performing image processing corresponding to the mode on at least part of the monochrome correction image and output the generated processed image to the display unit.

8. The imaging apparatus according to claim 7,
wherein the processor is configured to generate the processed image by performing at least one of enlargement processing, edge extraction processing, edge enhancement processing, and noise reduction processing on at least part of the monochrome correction image.

9. The imaging apparatus according to claim 7,
wherein the processor is configured to generate the processed image by performing enlargement processing and at least one of edge extraction processing, edge enhancement processing, and noise reduction processing on at least part of the monochrome correction image.

10. An imaging apparatus comprising:
a pupil division optical system including a first pupil transmitting light of a first wavelength band and a second pupil transmitting light of a second wavelength band different from the first wavelength band;
an imaging device configured to capture an image of light transmitted through the pupil division optical system and a first color filter having a first transmittance characteristic and light transmitted through the pupil division optical system and a second color filter having a second transmittance characteristic partially overlapping the first transmittance characteristic, and output the captured image;
a correction unit configured to output at least one of a first monochrome correction image and a second monochrome correction image as a monochrome correction image, the first monochrome correction image being an image generated by correcting a value that is based on components overlapping between the first transmittance characteristic and the second transmittance characteristic for the captured image having components that are based on the first transmittance characteristic, the second monochrome correction image being an image generated by correcting a value that is based on components overlapping between the first transmittance characteristic and the second transmittance characteristic for the captured image having components that are based on the second transmittance characteristic;
a user instruction unit configured to output point information that represents a point on the monochrome correction image in accordance with an instruction from a user;
a mark generation unit configured to generate a mark; and
a superimposition unit configured to superimpose the mark on the monochrome correction image or a processed image generated by processing the monochrome correction image on the basis of the point information and output the monochrome correction image or the processed image on which the mark is superimposed to a display unit.

11. The imaging apparatus according to claim 10,
wherein the correction unit is configured to output the first monochrome correction image and the second monochrome correction image, and
the imaging apparatus further comprises a selection unit configured to select at least one of the first monochrome correction image and the second monochrome correction image output from the correction unit and output the selected image as the selected monochrome correction image.

12. The imaging apparatus according to claim 11, further comprising a selection instruction unit configured to instruct the selection unit to select at least one of the first monochrome correction image and the second monochrome correction image,
wherein the selection unit is configured to select at least one of the first monochrome correction image and the second monochrome correction image in accordance with an instruction from the selection instruction unit.

13. An endoscope apparatus comprising the imaging apparatus according to claim 1.
